(19) United States
(12) Patent Application Publication
(10) Pub. No.: US 2006/0027429 A1
(43) Pub. Date: Feb. 9, 2006

(54) Composite brake drum

(76) Inventors: Donn Knight, Troy, MI (US); Donald Davidson, Washington, MI (US)

Correspondence Address: CARLSON, GASKEY & OLDS, P.C., 400 WEST MAPLE ROAD, SUITE 350, BIRMINGHAM, MI, 48009, US

(21) Appl. No.: 10/911,087

(22) Filed: Aug. 4, 2004

(51) Int. Cl. F16D 51/00

(52) U.S. Cl. 188/74

(57) ABSTRACT

A composite brake drum includes an outer component having an outer surface and an inner surface defining an internal cavity. The composite brake drum also includes an inner liner that is mounted within the internal cavity and is attached to the inner surface. The inner liner is made from a metal matrix composite such as silicon carbide aluminum (SiCAl), for example. The outer component is formed from cast iron or stamped steel. The metal matrix composite provides a braking surface that is less corrosive than a braking surface that would be provided by ferrous materials.

### TECHNICAL FIELD

The subject invention relates to a composite brake drum with a metal matrix composite liner that provides a less corrosive wear surface.

### BACKGROUND OF THE INVENTION

A brake drum is formed as a cylindrical component having an outer surface and an inner surface defining an internal cavity. The inner surface provides a braking surface, also referred to as a wear surface, which is selectively engaged by a brake shoe assembly. The brake shoe assembly is mounted within the internal cavity and includes a pair of shoes, each of which supports a brake lining. During normal vehicle operation, the brake drum is rotating while the shoes are non-rotating. In response to a braking command, the shoes are moved into engagement with the wear surface to slow or stop rotation of the brake drum.

Typically, brake drums are formed from cast iron and include a ferrous wear surface. This type of brake drum is heavy and the ferrous wear surface has a tendency to corrode. Corrosion significantly degrades the wear surface, which can adversely affect brake operation and brake lining wear.

In order to improve fuel economy, some brake drums are formed from a lightweight material. These brake drums must also provide a long lasting wear surface. One type of lightweight brake drum includes an outer cylindrical component having an outer surface and an inner surface with an inner component attached to the inner surface. The outer cylindrical component is formed from a metal matrix composite, which is much lighter than a conventional cast iron brake drum. The inner component is formed from a ferrous material that provides a ferrous wear surface.

While this configuration provides a lighter brake drum, the problem with corrosion still exists. With this type of brake drum, corrosion can affect adhesion of the brake linings on the shoes to the ferrous wear surface.

Thus, there is a need for a brake drum that has a less corrosive wear surface.

### SUMMARY OF THE INVENTION

A composite brake drum includes an outer cylindrical component and an inner liner. The outer cylindrical component has an outer surface and an inner surface that defines an internal cavity. The inner liner is mounted within the internal cavity and is attached to the inner surface to provide a braking or wear surface. The outer cylindrical component is formed from a first material and the inner liner is formed from a second material that is less corrosive than the first material.

Preferably, the second material is a metal matrix composite. In one example, the metal matrix composite includes silicon carbide aluminum (SiCAl). In one disclosed embodiment, the first material is cast iron and the inner liner is either press-fit or cast into the internal cavity of the outer cylindrical component. In another disclosed embodiment, the first material is stamped steel and the inner liner is cast or press fit into the internal cavity of the outer cylindrical component.

In one disclosed embodiment, the outer cylindrical component includes a plurality of protrusions formed on the inner surface. The plurality of protrusions provides a good attachment surface for a cast inner liner. In one example, the plurality of protrusions is formed as a plurality of ribs with each rib having a generally trapezoidal profile.

The subject invention provides a composite brake drum with improved lining-to-drum adhesion characteristics. These and other features of the present invention can be best understood from the following specification and drawings, the following of which is a brief description.

### BRIEF DESCRIPTION OF THE DRAWINGS

FIG. 1 is a schematic side cross-sectional view of a brake drum incorporating the subject invention.

FIG. 2 is a schematic side cross-sectional view, partially broken away, that shows one example of a brake drum including a plurality of protrusions.

FIG. 3 is one example of a protrusion profile.

### DETAILED DESCRIPTION OF THE PREFERRED EMBODIMENT

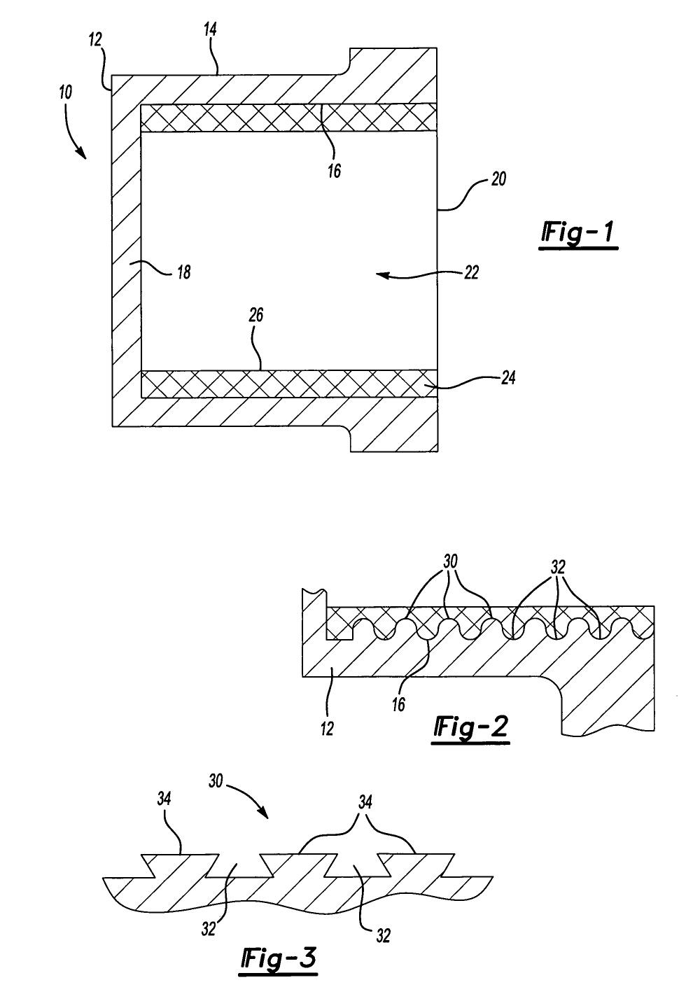

A brake drum, shown generally at 10 in FIG. 1, includes an outer component 12 having an outer surface 14 and an inner surface 16. The outer component 12 is generally cylindrical and has a closed end 18 and an open end 20 to define an internal cavity 22.

The brake drum 10 also includes an inner component 24 that is mounted within the internal cavity 22, and which is attached to the inner surface 16 of the outer component 12. The inner component 24 provides a braking surface 26, which is also referred to as a wear surface. A brake shoe assembly (not shown) includes a brake lining that is selectively moved into engagement with the braking surface 26 in response to a braking command.

The outer component 12 is formed from a first material and the inner component 24 is formed from a second material that is less corrosive than the first material. The first material is preferably a cast iron or stamped steel material, however, other materials could also be used. The second material is preferably a metal matrix composite material. One example of a metal matrix composite material is silicon carbide aluminum (SiCAl), however, other metal matrix composites could also be used.

In one example, the outer component 12 is a cast iron brake drum and the inner component 24 is a liner. The inner surface 16 can be machined out by a predetermined amount, such as six (6) millimeters, for example, and the liner can be press-fit into place within the internal cavity 22. The press-fit generates a sufficient retaining force between the cast iron brake drum and the liner to permanently attach the liner to the cast iron brake drum. Dowel pins or some other shear retainer may also be required to permanently attach the liner to the cast iron brake drum.

In another example, the outer component 12 is a cast iron brake drum that includes a plurality of protrusions 30 formed on the inner surface 16 (see FIG. 2). The protrusions 30 are preferably formed during the casting process. Each protrusion 30 is preferably spaced apart from an adjacent protrusion 30 by a groove 32. The inner component 24, formed from the metal matrix composite, is then cast into the outer component 12, with the metal matrix composite material binding to the protrusions 30. This configuration may be more beneficial to higher production volumes than press-fitting would be.

Preferably, the protrusions 30 are formed as a plurality of ribs 34 with each rib 34 having a trapezoidal profile (see FIG. 3). While a trapezoidal profile is preferred, it should be understood that other profiles could also be used. Further, the protrusions 30 and/or grooves 32 can extend continuously or discontinuously about the inner surface 16 of the outer component 12.

In another example, the outer component 12 is formed from a stamped steel material and the inner component 24 is formed from the metal matrix composite material. The metal matrix composite material is cast or pressed into the outer component 12, as described above. The outer component 12 formed from stamped steel material may or may not include protrusions. In this configuration, the metal matrix composite might be formulated to minimize thermal expansion, to better match the ferrous material forming the outer component, while also providing superior wear properties compared to traditional cast iron. This formulation process is within the knowledge of one of ordinary skill in the art.

In each of these configurations, the metal matrix composite provides a less corrosive wear surface than would be provided by a traditional ferrous wear surface. This significantly reduces the propensity for the brake lining to adhere to the wear surface.

Although a preferred embodiment of this invention has been disclosed, a worker of ordinary skill in this art would recognize that certain modifications would come within the scope of this invention. For that reason, the following claims should be studied to determine the true scope and content of this invention.

1. A brake drum comprising:
an outer component defining an internal cavity, said outer component being formed from a first material; and
an inner component attached to said outer component within said internal cavity, said inner component defining a braking surface wherein said inner component is formed from a second material that is less corrosive than said first material said inner component forming a liner that is attached to an inner surface of said outer component with a press fit.

2. The brake drum according to claim 1 wherein said first material comprises cast iron and said second material comprises a metal matrix composite.

3. The brake drum according to claim 2 wherein said metal matrix composite includes silicon carbide aluminum (SiCAl).

4. (canceled)

5. The brake dram according to claim 1 wherein said press-fit generates a permanent retaining force between said liner and said outer component.

6-8. (canceled)

9. The brake drum according to claim 1 wherein said first material comprise stamped steel and said second material comprises a metal matrix composite.

10. The brake drum according to claim 9 wherein said metal matrix composite includes silicon carbide aluminum (SiCAl).

11. (canceled)

12. A brake drum comprising:
an outer cylindrical component having an outer surface and an inner surface defining an internal cavity, said outer cylindrical component including a plurality of ribs formed on an inner surface of said outer cylindrical component and separated from each other by a plurality of grooves; and
an inner liner mounted within said internal cavity and attached to said inner surface to provide a braking surface wherein said inner liner is formed from a metal matrix composite that is cast to engage said plurality of ribs.

13. The brake drum according to claim 12 wherein said metal matrix composite includes silicon carbide aluminum (SiCAl).

14. The brake drum according to claim 13 wherein said outer component is formed from cast iron.

15. The brake drum according to claim 13 wherein said outer component is formed from stamped steel.

16. A method of forming a brake drum comprising:
forming an outer cylindrical component having an outer surface and an inner surface defining an internal cavity wherein the inner surface includes a plurality of ribs;
forming an inner liner from a metal matrix composite for receipt within the internal cavity; and
casting the inner liner around the plurality of ribs to permanently attach the inner liner to the inner surface to provide a braking surface.

17-18. (canceled)

19. The method according to claim 16 including forming the outer cylindrical component from cast iron.

20. The method according to claim 16 including forming the outer cylindrical component from stamped steel.

21. The brake drum according to claim 12 wherein each rib has a generally trapezoidal profile.

22. The brake drum according to claim 21 wherein each rib is separated from an adjacent rib by one of said plurality of grooves with each groove having a groove cross-sectional profile that is generally the same as a rib cross-sectional profile.

23. The brake drum according to claim 21 wherein each rib has a base portion formed at said inner surface that extends to a distal end portion and wherein each rib includes obliquely orientated side edges extending from said base portion to said distal end portion.

24. The brake drum according to claim 23 wherein said base portion is narrower than said distal end portion.

25. The method according to claim 16 including forming the inner surface with a plurality of grooves and separating each rib from an adjacent rib with one of the plurality of grooves.

26. The method according to claim 25 including forming each rib with side edges that extend obliquely relative to the inner surface of the outer cylindrical component.

27. The method according to claim 25 wherein the plurality of ribs and the plurality of grooves have corresponding cross-sectional profiles.
